(19) United States
(12) Patent Application Publication
(10) Pub. No.: US 2017/0014836 A1
(43) Pub. Date: Jan. 19, 2017

(54) METHOD AND SYSTEM FOR RECOVERING WEIGHTING MATERIAL AND MAKING A WEIGHTED DRILLING FLUID

(71) Applicant: Kayden Industries Limited Partnership, Calgary (CA)

(72) Inventor: Russell FISHER, Millarville (CA)

(21) Appl. No.: 15/302,424

(22) PCT Filed: Apr. 7, 2015
(86) PCT No.: PCT/CA2015/050281

§ 371 Date: Oct. 6, 2016

Related U.S. Application Data
(60) Provisional application No. 61/976,341, filed on Apr. 7, 2014.

(51) Int. Cl. B04B 1/20; E21B 21/06; B04B 11/02; B04B 15/06; B01D 21/26; B04B 5/10

(52) U.S. Cl. CPC B04B 1/20; B01D 21/262; B04B 5/10; B04B 11/02; B04B 15/06; E21B 21/065; B04B 2001/2041; E21B 21/08

(57) ABSTRACT

A horizontal centrifuge, method and system of use, recovers weighting materials from a returned drilling fluid slurry. A clean fluid is delivered, through a clean fluid pipe arranged axially at the hub, to solids discharge ports. The clean fluid is directed radially and circumferentially outwardly at the discharge ports for mixing homogeneously with the recovered weighting materials from forming a reconstituted weighted drilling mud. The reconstituted weighted drilling mud can then be delivered to a rig mud tank for use in a drilling operation. In the system, a drilling fluid and low gravity solids, which are separated from the weighting materials in the horizontal centrifuge, being a first centrifuge, are directed to a second centrifuge which is capable of removing the low gravity solids, thereby producing a clean fluid. The clean fluid is recycled to the first centrifuge for delivery through the clean fluid pipe.

### FIELD

Embodiments disclosed herein are related to solids removal and management, and more particularly, to system and apparatus with integrated weighting material recovery for making a reconstituted weighted drilling fluid therefrom and therein.

### BACKGROUND

Oilfield drilling fluid or “mud” is typically a water-based or oil-based liquid, in which solids are purposefully suspended to impart desired density and rheological properties thereto. Drilling fluids typically act as a lubricant to cool drill bits, to facilitate faster drilling rates and to lift drill cuttings to surface with the returned drilling fluid.

It is a common practice in drilling of wellbores, particularly in the oil and gas industry, to add weighting materials to drilling muds or fluids to increase density to balance and control formation pressure. The weighting materials are typically finely ground solid materials having a high specific gravity, for example barite, calcium carbonate and hematite.

If there is insufficient drilling fluid density, the well will be in an underbalance condition and formation fluids will enter the wellbore. Uncontrolled production of formation fluids is critical and may result in a “kick” and a potentially deadly blowout. Mud pits at surface are typically carefully monitored and, if the level therein increases which is indicative that a kick is taking place, the wellbore may need to be shut in. Shut-in of the well results in, at a minimum, lost time and increased costs to the drilling operation associated therewith. Blowouts may be catastrophic to the drilling operation and to the surrounding environment.

Further, if the density of the mud is too low, the wellbore may become unstable as the hydrostatic pressure provided by a column of the drilling fluid is insufficient to balance formation pressure. In the case of vertical wells, there may be sufficient hydrostatic pressure as a result of the height of the column of drilling fluid alone, however in the case of directional wellbore, particularly horizontal wellbores, the hydrostatic pressure may be insufficient without the addition of weighting agents.

When the drilling fluid is returned to surface, the fluid carries the weighting materials and the drill cuttings therewith. Solids control apparatus, such as shale shakers, are initially used to remove the very large solids. The screened returned mud may then be directed to one or more centrifuges or hydrocyclones to remove smaller, lower gravity solids. Unfortunately, in the process of removing the undesirable solids, the weighting materials are also readily removed as well. The weighting materials are then discarded with the solids and fresh weighting materials are required to be added to the cleaned drilling fluid for subsequent use thereof. Discard of the weighting materials may add significantly to the cost of the drilling operation.

Others have attempted to recover the weighting material, such as in two stage operations where a first centrifuge, typically a horizontal centrifuge colloquially known as a horizontal decanter centrifuge, is operated at a low G-force, for example 600G to 900G for removing the weighting material and a second horizontal centrifuge operated at a higher G-force, for example, greater than 900G, for removal of low gravity solids and fine formation solids therefrom. Weighting materials, such as barite, recovered from the first centrifuge can be added to the clean drilling fluid produced from the second centrifuge in the preparation of new weighted drilling fluids. Recovered weighting material however has a very thick, sticky, putty-like nature and tends clump and to plug solids discharge ports in the centrifuge and/or in the hopper, making removal and collection problematic. Further, clumps of material, which may form on the lid and/or pan of the centrifuge after being thrown thereon from the solids discharge ports, may reach a very large size before the clumps fall by gravity into the hopper. Clumps, once formed, do not readily remix with a drilling fluid without a high degree of agitation.

Applicant is aware that others have introduced clean drilling fluid through a port, located in a lid or shroud, and directed inwardly at the solids discharge end of the first centrifuge in an attempt to mix the weighting material with the fluid for forming a drilling fluid for delivery to rig mud tanks. While such systems have shown some slight improvement over previous systems, they have overall proven ineffective as the introduced fluid tends to channel through the clumps of recovered weighting materials and does not mix sufficiently therewith to produce a homogeneous weighted fluid.

Clearly there is interest in apparatus and systems for recovery of the weighting material and methods for effective and efficient recycling thereof for use in the same or other drilling operations.

### SUMMARY

Embodiments disclosed herein utilize a horizontal decanter-type centrifuge for separating a returned weighted drilling fluid slurry, from which large solids have previously been removed, into at least weighting materials and a drilling fluid containing low gravity solids. A screw conveyor, supported horizontally within a bowl of the centrifuge, moves the separated weighting materials towards solids discharge ports at a distal end of a conical portion of the bowl. The drilling fluid and low gravity solids are discharged from a proximal end of a cylindrical portion of the bowl. A slurry pipe extends through the hub for delivering the slurry intermediate a cylindrical portion of the centrifuge's bowl for separation therein. Clean fluid is delivered to the distal end of the conical portion of the bowl at the solids discharge ports using a clean fluid pipe which extends through the hub. Clean fluid is discharged from a discharge end of the clean pipe toward a baffle spaced axially therefrom. The clean fluid is directed radially outwardly for distribution radially and circumferentially at the solids discharge ports for mixing homogeneously with the discharging weighting materials. A reconstituted, weighted drilling fluid is formed which is sent to rig mud tanks for reuse.

In embodiments, the slurry pipe and the clean fluid pipe are concentrically arranged. In an arrangement where the slurry pipe and the clean fluid pipe enter and extend through the hub from the proximal end of the cylindrical portion of the bowl, the clean fluid pipe extends through the slurry pipe, to the solids discharge ports, forming an annulus therebetween. Slurry is introduced intermediate the cylindrical portion of the bowl through the annulus.

In an arrangement wherein the slurry pipe and the clean fluid pipe enter the hub at the distal end of the conical portion of the bowl, the clean fluid pipe terminates at the discharge ports therein. The slurry pipe extends through the clean fluid pipe forming an annulus therebetween. The slurry pipe terminates intermediate the cylindrical portion of the bowl. The clean fluid is delivered to the solids discharge ports within the annulus.

The bowl and hub, supporting the screw conveyor, can be rotated at different rotational speeds.

In an embodiment of a system taught herein, a centrifuge according to embodiments taught herein is a first centrifuge which is operated at a first rotational speed. The drilling fluid with the low gravity solids, discharged from the proximal end of the cylindrical portion of the bowl, is delivered to a second centrifuge capable of removing the low gravity solids therefrom and producing the clean fluid. The second centrifuge is operated at a second, typically higher, rotation speed. The clean fluid is recycled from the second centrifuge to the first centrifuge for delivery through the clean fluid pipe.

In a broad aspect, a horizontal centrifuge has a rotatable bowl housed within a pan and a lid. The bowl comprises a cylindrical portion and a conical portion having a plurality of circumferentially spaced-apart solids discharge ports at a distal end thereof and a conveyor hub disposed longitudinally within the bowl and supported for rotation therein. The hub supports a screw conveyor attached therealong for co-rotation therewith for separating weighting materials from drilling fluid and low gravity solids from a returned weighted drilling fluid slurry. The at least weighting materials are recovered therein for mixing with a clean fluid for forming a reconstituted, weighted drilling mud. The centrifuge comprises a slurry pipe extending axially through the conveyor hub for delivering the slurry intermediate the cylindrical portion. Rotation of the bowl causes the slurry to be separated into a fluid containing the low gravity solids and the weighting materials, the fluid and low gravity solids being discharged from a proximal end of the cylindrical portion. Rotation of the screw conveyor causes the weighting materials to be conveyed to the discharge ports. A clean fluid pipe extends axially through the conveyor hub for discharging a clean fluid at the discharge ports. Clean fluid discharged from the clean fluid pipe is distributed radially and circumferentially outwardly from the clean fluid pipe for mixing substantially homogeneously with the discharging weighting materials for forming the reconstituted, weighted drilling fluid.

In another broad aspect, a method for recovering weighting materials from a returned drilling fluid slurry, from which large solids have been removed, forms a reconstituted, weighted drilling fluid therefrom, in a horizontal centrifuge having a rotatable bowl comprising a cylindrical portion and a conical portion having a plurality of circumferentially spaced-apart solids discharge ports at a distal end thereof and a conveyor hub disposed longitudinally within the bowl and supported for rotation therein. The hub supports a screw conveyor attached therealong for co-rotation with the hub. The method comprises delivering the returned slurry intermediate the cylindrical portion of the bowl, the slurry comprising at least weighting materials, low gravity solids and a drilling fluid. The weighting materials are separated from the slurry in the rotating bowl, the low gravity solids being retained with the drilling fluid for discharge at a proximal end of the cylindrical portion. The separated weighting materials are conveyed from the cylindrical portion toward the distal end of the conical portion with the screw conveyor for discharge from the solids discharge ports. A clean fluid is delivered to the distal end of the conical portion. The clean fluid is distributed radially and circumferentially outwardly toward the discharge ports and the weighting materials, for mixing substantially homogeneously with the weighting materials for forming the reconstituted weighted drilling fluid.

In yet another broad aspect, a system for recovering at least weighting materials from a returned drilling fluid slurry and for forming a reconstituted weighted drilling fluid therewith comprises a first horizontal centrifuge. The first horizontal centrifuge comprises a rotatable bowl housed within a pan and a lid, the bowl comprising a cylindrical portion and a conical portion having a plurality of circumferentially spaced-apart solids discharge ports at a distal end thereof and a conveyor hub disposed longitudinally within the bowl and supported for rotation therein. The hub supports a screw conveyor attached therealong for co-rotation with the hub for separating at least weighting materials from fluid and low gravity solids from the returned weighted drilling fluid slurry, the weighting materials being recovered therein for mixing with a clean fluid for forming a reconstituted, weighted drilling mud. The centrifuge comprises a slurry pipe extending axially at the conveyor hub for delivering the slurry intermediate the cylindrical portion. Rotation of the bowl causes the slurry to be separated into the drilling fluid containing the low gravity solids and the weighting materials. The drilling fluid and low gravity solids are discharged from a proximal end of the cylindrical portion. Rotation of the hub causes the weighting materials to be conveyed to the discharge ports. A clean fluid pipe extending axially at the conveyor hub discharges a clean fluid at the discharge ports. The clean fluid, discharged from the clean fluid pipe, is distributed radially and circumferentially outwardly therefrom for mixing substantially homogeneously with the discharging weighting materials for forming the reconstituted, weighted drilling fluid. A second horizontal centrifuge, arranged in series with the first centrifuge, receives the drilling fluid and the low gravity solids discharged from the proximal end of the first centrifuge and separating the low gravity solids therefrom for forming the clean fluid. The clean fluid is recycled to the clean fluid pipe of the first centrifuge.

### BRIEF DESCRIPTION OF THE DRAWINGS

FIG. 1 is a side view of a horizontal centrifuge according to an embodiment taught herein, shown having a lid or outer shroud covering internal components therein;

FIG. 2 is a side view of the horizontal centrifuge of FIG. 1, the shroud removed for viewing a horizontal bowl supported for rotation and having cylindrical and conical portions therein;

FIG. 3 is a cross-sectional view according to FIG. 2, illustrating a hub having a screw conveyor supported thereon for rotation within the bowl, the hub having coaxially-extending, in this case concentric, feed tubes supported therein, one being a slurry feed tube for conveying a returned drilling fluid slurry intermediate the cylindrical portion of the bowl for separation therein and the other being a clean fluid tube for distributing a clean drilling fluid adjacent solids discharge ports at a distal end of the conical portion for mixing with weighted materials discharged therefrom for forming a reconstituted, homogeneous drilling fluid for discharge to a hopper for delivery to rig mud tanks;

FIG. 4A is a perspective view according to FIG. 3, flights of rotors and other internal components having been removed therefrom for viewing the inner and outer fluid feed tubes therein;

FIG. 4B is an illustration of a radial and circumferential distribution of clean fluid exiting the clean fluid pipe, a baffle plate having been removed for clarity;

FIG. 5A is an illustration of an arrangement wherein the slurry and clean fluid feed tubes enter the hub along a horizontal axis of the centrifuge at the cylindrical end of the bowl, a gear box being operatively connected to the centrifuge at the opposing conical end;

FIG. 5B is an illustration of an arrangement wherein the slurry and clean fluid feed tubes enter the hub along the horizontal axis of the centrifuge at the conical end, the gear box being operatively connected to the centrifuge at the opposing cylindrical end of the bowl; and

FIG. 6 is an illustration of a system for weighting material recovery incorporating a first centrifuge, according to embodiments shown in FIGS. 1 to 5B, for forming a reconstituted weighted drilling fluid using weighting materials recovered therein and a second centrifuge for producing a clean fluid from fluid and low gravity solids separated from the weighting materials in the first centrifuge, the clean fluid being recycled to the first centrifuge.

### DETAILED DESCRIPTION

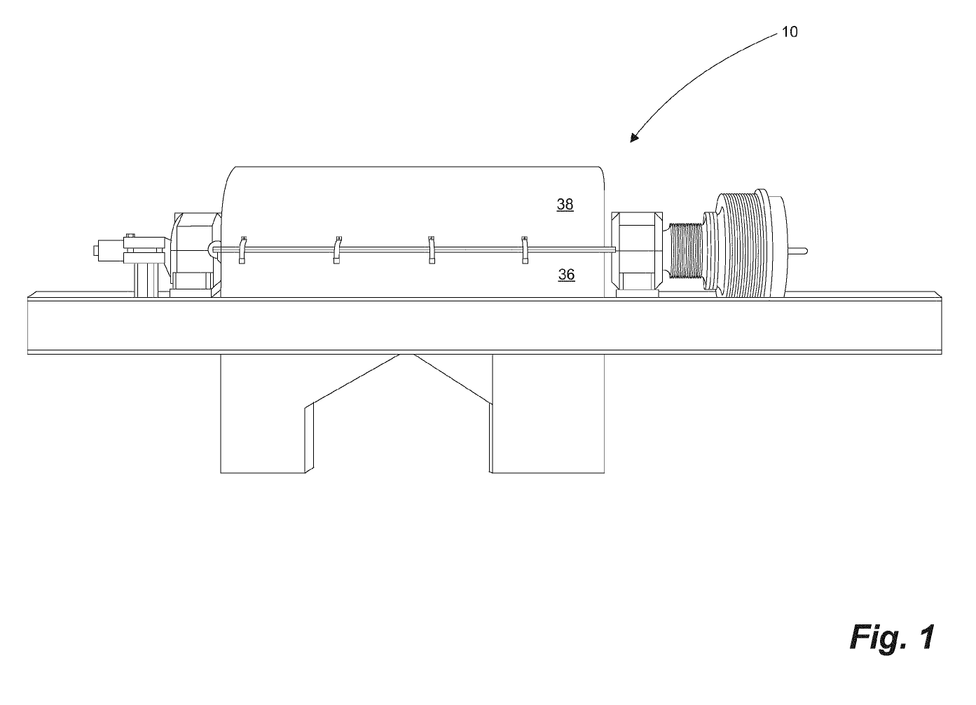

Having reference to FIGS. 1 to 5B, a horizontal centrifuge 10 is shown for use on recovering weighting materials 12, such as barite, calcium carbonate, hematite, or mixtures thereof, from a returned drilling fluid slurry 14. The recovered weighting materials 14 are reconstituted in the centrifuge 10 with a clean drilling fluid 16, distributed therein for mixing with the recovered weighting materials so as to form a substantially homogeneous reconstituted weighted drilling fluid 18 therein.

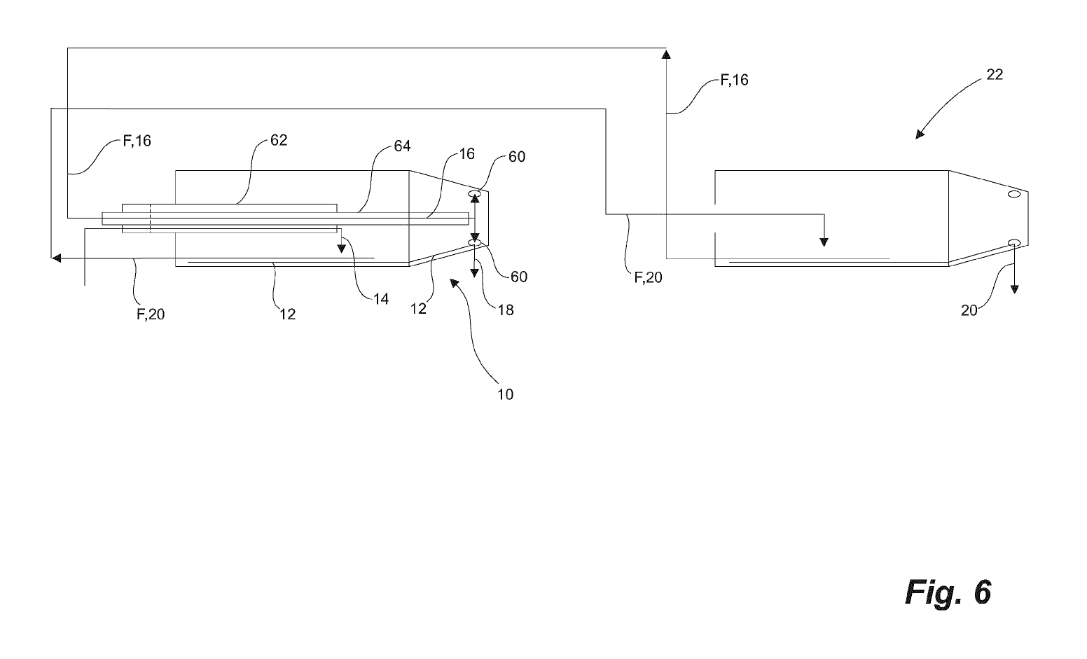

Having reference to FIG. 6, in a system taught herein, the horizontal centrifuge 10, according to embodiments taught herein, is a first centrifuge for separating the weighting materials 12 from the slurry 14. Drilling fluid F and low gravity solids 20, which are separated from the weighting materials 12 in the first centrifuge 10, are directed to a second, conventional horizontal centrifuge 22 for removal of the low gravity solids 20 from the drilling fluid F to produce the clean drilling fluid 16 for recycle to the first centrifuge 10. The second centrifuge 22 is generally operated at a higher rotational speed than the first centrifuge 10.

In greater detail, having reference to FIGS. 1 to 4, the centrifuge 10 comprises a horizontally extending bowl 30, having a cylindrical portion 32 and a conical portion 34, housed within a pan 36 and a lid 38.

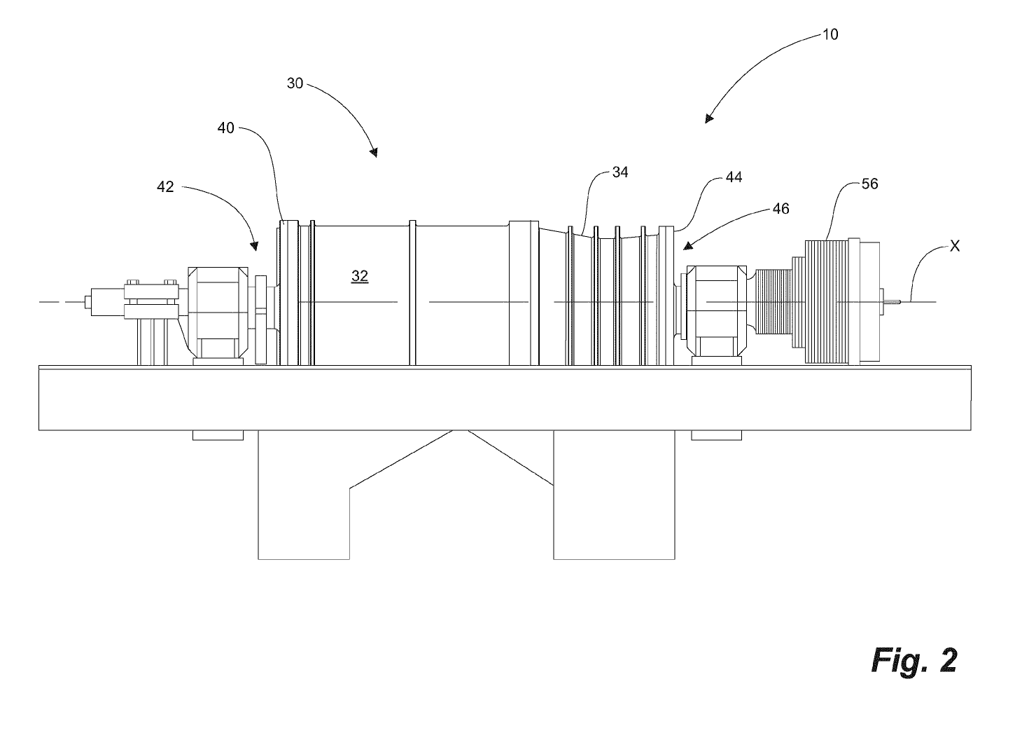

Best seen in FIGS. 2, 3 and 4A, the bowl 30 is supported for rotation about a horizontal axis X between a trunnion 40 at a proximal end 42 of the cylindrical portion 32 and a trunnion 44 at a distal end 46 of the conical portion 34. A hub 50, having a bore 52 formed therethrough, extends through the bowl 30 and is supported for rotation therein along the axis X. A screw conveyor 54 is supported on the hub 50 for co-rotation therewith. A gear box 56 is operatively connected to the bowl 30 and hub 50 for relative rotation therebetween, the bowl 30 and hub 50 being generally rotated at different speeds. As in a conventional horizontal centrifuge, the heavier weighting materials are directed to an outer wall 58 of the bowl 30 and are scraped or moved therealong by the screw conveyor 54 to a plurality of circumferentially spaced solids discharge ports 60, located adjacent the distal end 46 of the conical portion 34, for discharge therefrom.

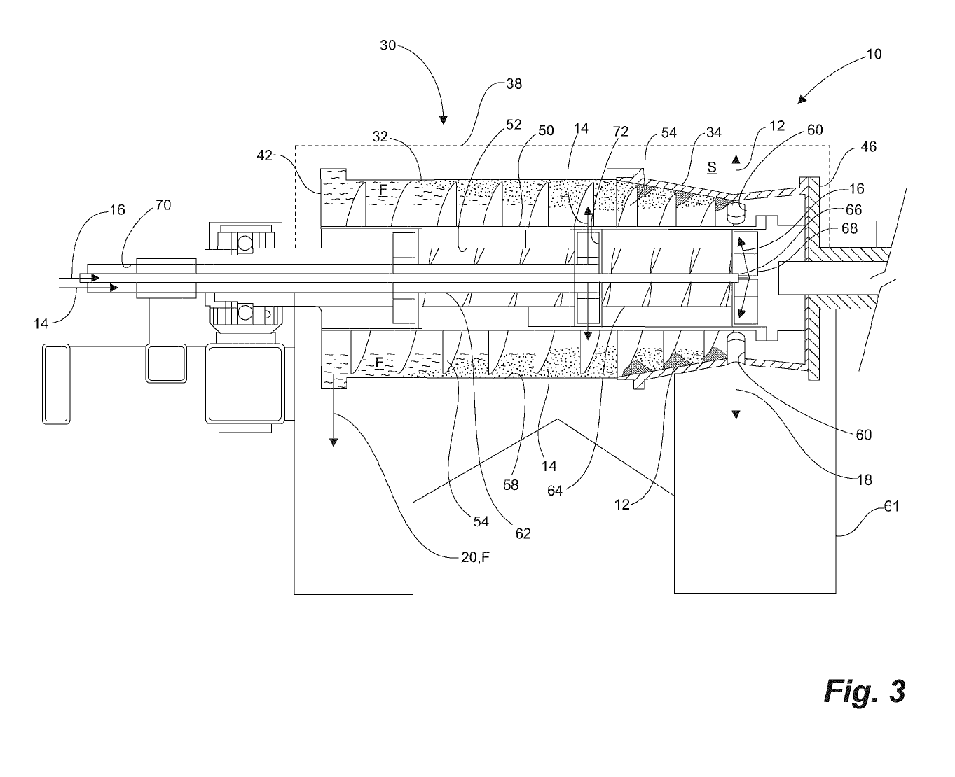

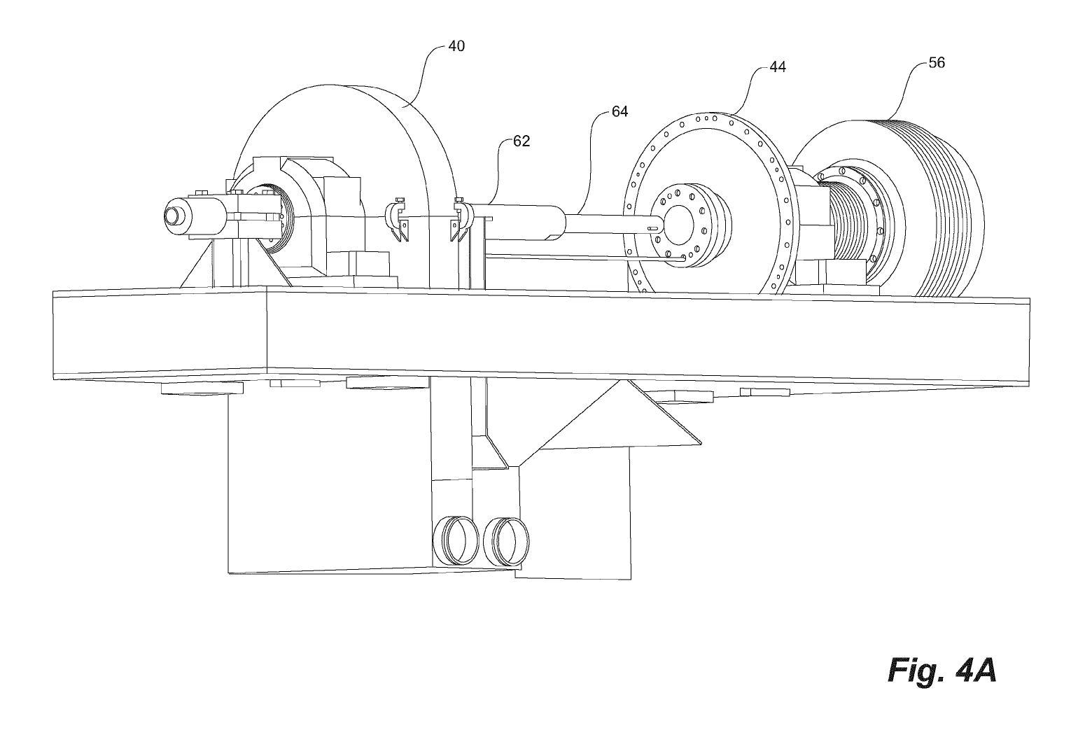

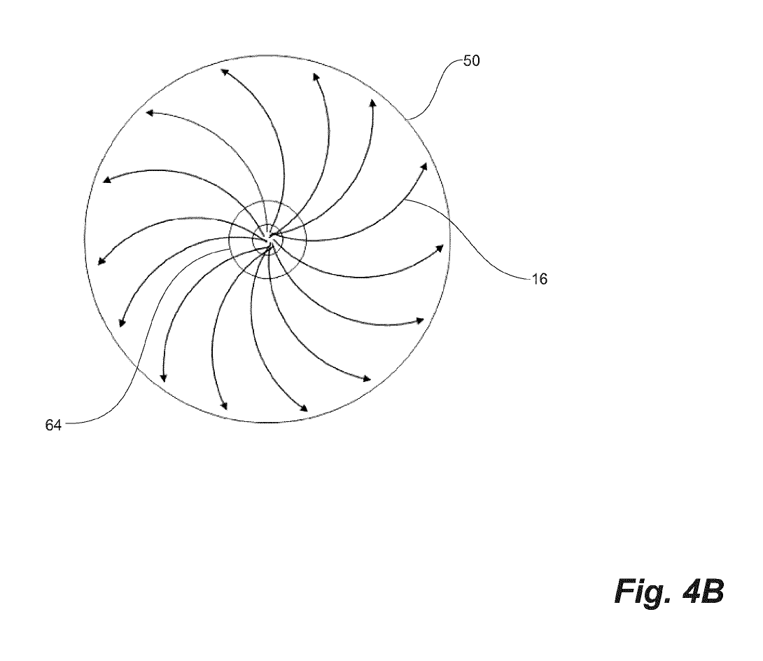

Best seen in FIGS. 3, 4A and 4B, unlike a conventional horizontal centrifuge however, coaxially-extending slurry and clean fluid conduits or pipes 62,64 extend into the centrifuge 10, at or through the hub's bore 52, for delivery of the returned drilling fluid 14, containing the weighting materials 12 and low gravity solids 20, and clean fluids 16 therein, respectively. In embodiments, the slurry pipe 62 and clean fluid pipe 64 are concentrically arranged. Appropriate slip-connections are provided between the non-rotating sources of the fluids 14,16 and the rotation pipes 62,64.

As illustrated in FIGS. 3 and 4B, a homogenous mixing of the recovered weighting materials 12 and clean fluid 16 occurs. Clean fluid 16, axially exits a discharge end 66 of the clean pipe 64, generally horizontally and encounters a baffle plate 68 spaced axially therefrom. The baffle plate 68 redirects the clean drilling fluid 16 radially outwardly toward the solids discharge ports 60 in the bowl's conical portion 34. Rotation of the hub 50 distributes the radially-directed clean fluid 16 toward the discharge ports 60 causing the clean drilling fluid 16 to mix with the weighting materials 12 at or discharging through the discharge ports 60. Mixing forms a homogeneous, reconstituted weighted drilling fluid 18. As the weighting materials 12 are picked up by the clean fluid 16 and mixed therewith, plugging of the discharge ports 60 and clumping on an inner surface S of the pan 36 and lid 38 are minimized. In embodiments, a hopper 61 is fluidly connected to the solids discharge ports 60 for collection of the reconstituted weighted drilling mud 18. The reconstituted weighted drilling mud 18 is delivered therefrom to rig mud tanks (not shown).

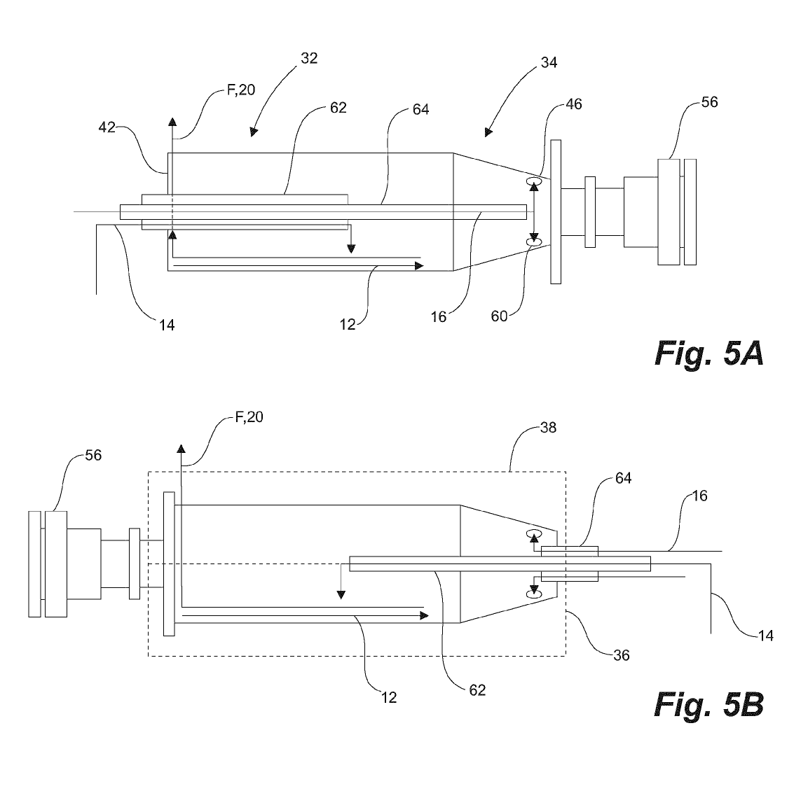

In a first arrangement, as shown in FIGS. 3 and 5A, the slurry pipe 62 and clean fluid pipe 64 are concentric. The slurry pipe 62, entering and extending the proximal end 42 of the cylindrical portion 32 terminates intermediate the cylindrical portion 32. The clean fluid pipe 64 extends through the slurry pipe 62 and terminates adjacent the solids discharge ports 60 at the distal end 46 of the conical portion 34. The returned drilling fluid 14, which has had coarse solids removed, such as at a shale shaker (not shown), is introduced to the centrifuge 10 in an annulus 70 formed between the inner, clean fluid pipe 64 and the outer, slurry pipe 62. The returned drilling fluid 14 is delivered intermediate therein to the cylindrical portion 32, such as through fluid ports 72 in the screw conveyor 54. The bowl 30 is rotated at a relatively low speed, suitable for stripping the at least weighting materials 12 from the returned drilling fluid 14 and leaving the fluid F with the low gravity solids 20 therein. For example, the bowl 30 is rotated in the range from about 800 rpm to about 1000 rpm.

The weighting materials settle from the slurry 14 along the cylcindrical portion. The screw conveyor 54 moves the separated weighting materials 12 toward the conical portion 34 for discharge through solids discharge ports 60 thereat. The drilling fluid F, containing at least the remaining low gravity solids 20 moves in the opposite direction toward the cylindrical portion 32, for discharge from the proximal end 42 thereof.

As the returned drilling fluid 14 is fed to the annulus 70, clean drilling fluid 16 is fed to the inner, clean fluid pipe 64 for discharge adjacent the solids discharge ports 60 as described above. The agitation caused by the radial and circumferential distribution of the clean fluid 16 aids in flushing the solids discharge ports 60 and mixing the clean drilling fluid 16 with the weighting materials 12 being discharged therethrough. Thus, plugging of the discharge ports 60 and apparatus downstream thereof is minimized and mixing of recovered at least weighting material 12 and clean fluid 16 is maximized.

In an alternate arrangement, as shown in FIG. 5B, the concentric clean fluid and slurry pipes 64,62 enter the centrifuge 10 from the distal end 46 of the conical portion 34. To facilitate this arrangement, the gear box 56 is relocated to be operatively connected to the centrifuge 10 adjacent the proximal end 42 of the cylindrical portion 32. In this arrangement, the clean fluid pipe 64 terminates adjacent the solids discharge ports 60 for distribution of the clean fluid 16 as previously described. The slurry pipe 62, which extends through the clean fluid pipe 64, terminates intermediate the cylindrical portion 32 for delivery of the returned drilling fluid thereto. The clean fluid is delivered through the annulus 70 formed therebetween. Movement of the weighting materials 12 and drilling fluid F with low gravity solids 20, within the centrifuge 10, remains as discussed above.

Having reference to FIG. 6, in greater detail, in the system for solids control and for integrated weighting material recovery, the drilling fluid F, containing the low gravity solids 20, which is discharged from the proximal end 42 of the first centrifuge 10, is delivered to the second, conventional centrifuge 22 for further clarification therein. The second centrifuge 22 is any centrifuge capable of removing the low gravity solids 20 to produce the clean fluid 16. In embodiments, the second centrifuge 22 is a conventional horizontal centrifuge. The second centrifuge 22 is rotated at a higher speed than the first centrifuge 10, the rotation speed being sufficient to remove the low gravity solids 20 from the drilling fluid F and produce the clean drilling fluid 16. For example, the second centrifuge 22 is operated at a rotational speed in the range from about 1500 rpm to about 3000 rpm. The clean drilling fluid 16 is then recycled to the first centrifuge 10 for delivery and distribution, by the clean fluid pipe 64, for mixing with the recovered weighting material 12 at the solids discharge ports 60. The reconstituted weighted drilling fluid 18, collected in the hopper 61, is sent to the rig mud tanks for further use.

1. A method for recovering weighting materials from a returned drilling fluid slurry, from which large solids have been removed, and forming a reconstituted, weighted drilling fluid therefrom, in a horizontal centrifuge having a rotatable bowl comprising a cylindrical portion and a conical portion having a plurality of circumferentially spaced-apart solids discharge ports at a distal end thereof and a conveyor hub disposed longitudinally within the bowl and supported for rotation therein, the hub supporting a screw conveyor attached therealong for co-rotation with the hub, the method comprising:
delivering the returned slurry intermediate the cylindrical portion of the bowl, the slurry comprising at least weighting materials, low gravity solids and a drilling fluid;
separating the weighting materials from the slurry in the rotating bowl, the low gravity solids being retained with the drilling fluid for discharge at a proximal end of the cylindrical portion;
conveying the separated weighting materials from the cylindrical portion toward the distal end of the conical portion with the screw conveyor for discharge from the solids discharge ports;
delivering a clean fluid to the distal end of the conical portion; and
distributing the clean fluid radially and circumferentially outwardly toward the discharge ports and the weighting materials, for mixing substantially homogeneously with the weighting materials for forming the reconstituted weighted drilling fluid.

2. The method of claim 1, wherein the horizontal centrifuge is housed in a lid and a pan, further comprising:
circumferentially distributing the substantially homogeneous reconstituted weighted drilling fluid exiting the discharge ports onto an inner surface of the lid and pan, the reconstituted weighed drilling fluid flowing therealong for discharge to a hopper.

3. The method of claim 1, wherein the delivery of the clean fluid and the radial and circumferential distribution thereof comprises:
conveying the clean fluid through a clean fluid pipe supported coaxially at the rotating conveyor hub for discharge at the discharge ports.

4. The method of claim 1, wherein the delivering the returned drilling fluid slurry comprises:
conveying the slurry through a slurry pipe supported coaxially at the rotating conveyor hub for discharge intermediate the cylindrical portion of the bowl.

5. The method of claim 4, wherein the slurry pipe extends from the proximal end of the cylindrical portion and terminates intermediate the cylindrical portion and a clean fluid pipe extends concentrically through the slurry pipe from the cylindrical end to the discharge ports at the distal end of the conical portion, forming an annulus therebetween, the method further comprising:
delivering the returned drilling mud through the annulus to intermediate the cylindrical portion while delivering the clean fluid through the clean fluid pipe to the discharge ports.

6. The method of claim 3, wherein the clean fluid pipe extends into the conical portion, terminating at the discharge ports and a slurry pipe extends concentrically through the clean fluid pipe, terminating intermediate the cylindrical portion distal forming an annulus therebetween, the method further comprising:
delivering the returned drilling mud through the slurry pipe to intermediate the cylindrical portion while delivering the clean fluid through the annulus to the distal end of the conical portion and the discharge ports.

7. The method of claim 1, further comprising:
rotating the bowl at a first rotational speed; and
rotating the conveyor hub and screw conveyor at a second rotation speed.

8. The method of claim 7, wherein the first rotational speed is different from the second rotational speed.

9. The method of claim 1, wherein the horizontal centrifuge is a first centrifuge, comprising:
feeding the drilling fluid and retained low gravity solids, discharged from the proximal end of the first centrifuge, to a second centrifuge;
operating the second centrifuge at a rotational speed higher than the first centrifuge for separating the low gravity solids from the drilling fluid for forming the clean fluid; and
recycling the clean fluid for distribution in the first horizontal centrifuge for forming the weighted drilling fluid.

10. The method of claim 9 further comprising:
operating the first centrifuge in a range from about 800 rpm to about 1000 rpm; and
operating the second centrifuge in a range from about 1500 rpm to about 3000 rpm.

11. The method of claim 9 wherein the second centrifuge is a horizontal centrifuge.

12. A horizontal centrifuge having a rotatable bowl housed within a pan and a lid, the bowl comprising a cylindrical portion and a conical portion having a plurality of circumferentially spaced-apart solids discharge ports at a distal end thereof and a conveyor hub disposed longitudinally within the bowl and supported for rotation therein, the hub supporting a screw conveyor attached therealong for co-rotation therewith for separating weighting materials from drilling fluid and low gravity solids from a returned weighted drilling fluid slurry, the weighting materials being recovered therein for mixing with a clean fluid for forming a reconstituted, weighted drilling mud, the centrifuge comprising:
a slurry pipe extending axially through the conveyor hub for delivering the slurry intermediate the cylindrical portion, rotation of the bowl causing the slurry to be separated into a drilling fluid containing the low gravity solids and the weighting materials, the drilling fluid and low gravity solids being discharged from a proximal end of the cylindrical portion, rotation of the screw conveyor causing the weighting materials to be conveyed to the discharge ports;
a clean fluid pipe extending axially through the conveyor hub for discharging a clean fluid at the discharge ports, wherein
clean fluid discharged from the clean fluid pipe is distributed radially and circumferentially outwardly therefrom for mixing substantially homogeneously with the discharging weighting materials for forming the reconstituted, weighted drilling fluid.

13. The horizontal centrifuge of claim 12, wherein a bore of the clean fluid pipe extends coaxially within the slurry pipe from a proximal end of the cylindrical portion and forming an annulus therebetween, the slurry pipe terminating intermediate the cylindrical portion of the bowl and the clean fluid pipe terminating at a distal end of the conical portion adjacent the solids discharge ports.

14. The centrifugal separator of claim 13, wherein the slurry is conveyed in the annulus for delivery intermediate the cylindrical portion.

15. The centrifugal separator of claim 12, wherein the slurry pipe is arranged coaxially within a bore of the clean fluid pipe from a distal end of the conical portion and forming an annulus therebetween, the clean fluid pipe terminating adjacent the solids discharge ports and the slurry pipe terminating intermediate the cylindrical portion.

16. The centrifugal separator of claim 15, wherein the clean fluid is conveyed in the annulus for delivery adjacent the solids discharge ports.

17. The horizontal centrifuge of claim 12 further comprising a baffle plate operatively connected to the hub for rotation therewith and spaced axially from a discharge end of the clean fluid pipe, wherein clean fluid axially exiting from the discharge end of the clean fluid pipe is caused to be directed radially outwardly toward the solids discharge ports for distribution radially and substantially circumferentially at the discharge ports during rotation of the hub.

18. The centrifugal separator of claim 12 further comprising a hopper, fluidly connected to the pan, for collecting the homogeneously mixed weighted drilling fluid discharged from the solids discharge ports for delivery to a rig mud tank therefrom.

19. A system for recovering at least weighting materials from a returned drilling fluid slurry and for forming a reconstituted weighted drilling fluid therewith, the system comprising:
a first horizontal centrifuge having
a rotatable bowl housed within a pan and a lid, the bowl comprising a cylindrical portion and a conical portion having a plurality of circumferentially spaced-apart solids discharge ports at a distal end thereof and a conveyor hub disposed longitudinally within the bowl and supported for rotation therein, the hub supporting a screw conveyor attached therealong for co-rotation with the hub, for separating at least weighting materials from the drilling fluid and low gravity solids from the returned weighted drilling fluid slurry, the weighting materials being recovered therein for mixing with a clean fluid for forming a reconstituted, weighted drilling mud, the centrifuge comprising:
a slurry pipe extending axially at the conveyor hub for delivering the slurry intermediate the cylindrical portion, rotation of the bowl causing the slurry to be separated into the drilling fluid containing the low gravity solids and the weighting materials, the drilling fluid and the low gravity solids being discharged from a proximal end of the cylindrical portion, rotation of the hub causing the weighting materials to be conveyed to the discharge ports; and
a clean fluid pipe extending axially at the conveyor hub for discharging a clean fluid at the discharge ports, wherein the clean fluid discharged from the clean fluid pipe is distributed radially and circumferentially outwardly therefrom for mixing substantially homogeneously with the discharging weighting materials for forming the reconstituted, weighted drilling fluid; and
a second horizontal centrifuge, arranged in series with the first centrifuge, for receiving the drilling fluid and the low gravity solids discharged from the proximal end of the first centrifuge and separating the low gravity solids therefrom for forming the clean fluid, wherein the clean fluid is recycled to the clean fluid pipe of the first centrifuge.

20. The system of claim 19, wherein the second centrifuge is rotated at a higher speed than the first centrifuge.

21. The system of claim 20 wherein the first centrifuge is operated in a range from about 800 rpm to about 1000 rpm and the second centrifuge is operated in a range from about 1500 rpm to about 3000 rpm.
